(19) United States
(12) Patent Application Publication
(10) Pub. No.: US 2018/0260463 A1
(43) Pub. Date: Sep. 13, 2018

(54) COMPUTER SYSTEM AND METHOD OF ASSIGNING PROCESSING

(71) Applicant: HITACHI, LTD., Tokyo (JP)

(72) Inventors: Kazumasa MATSUBARA, Tokyo (JP); Jun NEMOTO, Tokyo (JP)

(73) Assignee: HITACHI, LTD., Tokyo (JP)

(21) Appl. No.: 15/870,896

(22) Filed: Jan. 13, 2018

(30) Foreign Application Priority Data
Mar. 7, 2017 (JP) 2017-042896

(51) Int. Cl. G06F 17/30; G06F 9/50

(52) U.S. Cl. CPC G06F 17/30575; G06F 17/30979; G06F 9/5027; G06F 17/3012; G06F 17/30091

(57) ABSTRACT

A computer system comprising computers, having a database built on storage areas included in computers, the processor of at least one computer being configured to: identify data to be used in first processing in a case of receiving a request to execute the first processing; perform data inquiry for inquiring about presence of the data to be used in the first processing to computers providing the database; identify computers holding the data to be used in the first processing, based on responses to the data inquiry; and assign the first processing to at least one of computers holding the data to be used in first processing.

### CLAIM OF PRIORITY

The present application claims priority from Japanese patent application JP 2017-42896 filed on Mar. 7, 2017, the content of which is hereby incorporated by reference into this application.

### BACKGROUND OF THE INVENTION

This invention relates to a method of assigning a task in a computer system including a distributed database.

In recent years, for distributed processing of a massive amount of data to analyze the data, distributed databases such as distributed key value stores (KVS) have been employed. A KVS stores key-value pairs each composed of a key given as a hash value and a value of actual data.

The KVS is featured by high-speed data retrieval when the key is used as the search key; however, the data retrieval slows down when the value is used as the search key. For this reason, to obtain data using the value as the search key and analyze the obtained data, a system of a combination of a search engine and a KVS is used.

As well as data distribution, a system for distributing a task is also used. Since the processing load onto each node to execute the task decreases, the data analysis processing can be expedited. For example, US 2014/0372611 A discloses a technique to efficiently distribute the load based on the information on the distance between nodes.

### SUMMARY OF THE INVENTION

The technique according to US 2014/0372611 A has a problem that scaling out the node for managing the locational information (index information) of data is difficult; accordingly, when the load caused by data inquiries for inquiring about presence of specific data is concentrated on the node managing the locational information (index information) of data, the node becomes bottlenecked.

If it can be realized scale out of the nodes, data inquiries can be distributed; however, management will be complicated because the node managing the data and the node managing the index information are separate.

The present invention can be appreciated by the description which follows in conjunction with the following figures, wherein: a computer system comprises a plurality of computers, each of the plurality of computers including a processor, a storage device coupled to the processor, and a network interface coupled to the processor. The computer system has a database built on a plurality of storage areas included in at least one of the plurality of computers. The processor of at least one computer is configured to: identify data to be used in first processing in a case of receiving a request to execute the first processing; perform data inquiry for inquiring about presence of the data to be used in the first processing to at least one of the plurality of computers providing the database; identify at least one of the plurality of computers holding the data to be used in the first processing, based on at least one of a plurality of first responses to the data inquiry; and assign the first processing to the at least one of the plurality of identified computers holding the data to be used in first processing.

According to one aspect of the present invention, it can solve a bottleneck in assigning processing (a task) because the data inquiries do not concentrate on a specific computer. The problems, configurations, and effects other than those described above will become apparent by the descriptions of embodiments below.

### BRIEF DESCRIPTION OF THE DRAWINGS

The present invention can be appreciated by the description which follows in conjunction with the following figures, wherein:

FIG. 1 is a diagram for illustrating a configuration example of a computer system of Embodiment 1,

FIG. 2 is a diagram for illustrating an example of node management information held by a task management node in Embodiment 1,

FIG. 3 is a flowchart of an example of processing to be performed by index management module in Embodiment 1, and

FIG. 4 is a flowchart of an example of processing to be performed by task assignment module in Embodiment 1.

### DETAILED DESCRIPTION OF THE EMBODIMENTS

Hereinafter, embodiments of this invention are described with reference to the drawings. Throughout the drawings, the same elements are denoted by the same reference signs to omit duplicate explanation.

### Embodiment 1

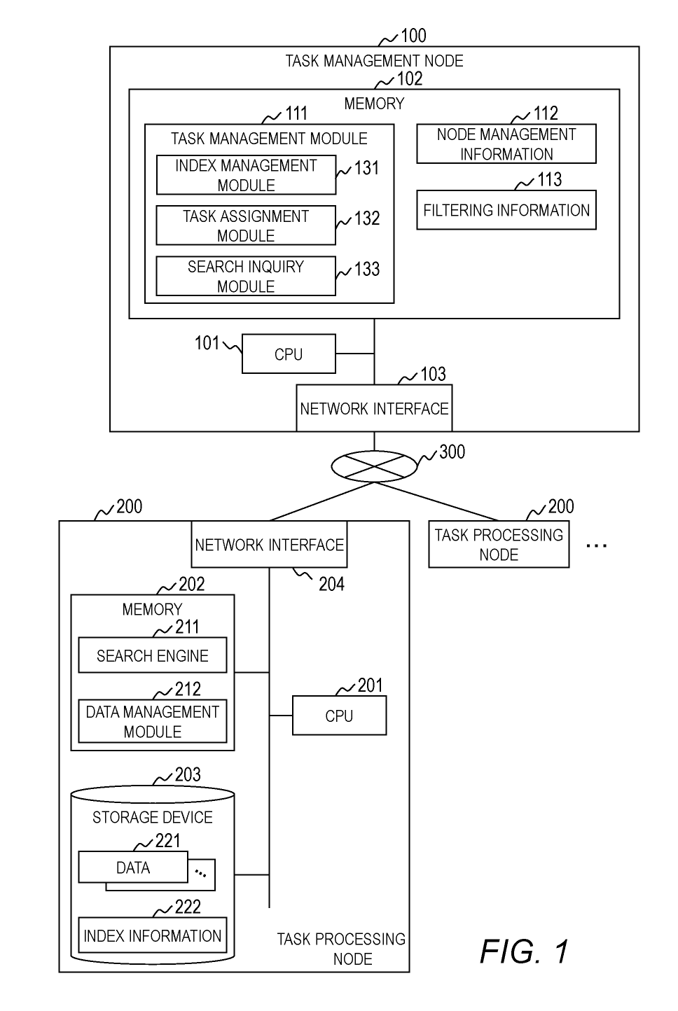

FIG. 1 is a diagram for illustrating a configuration example of a computer system of Embodiment 1.

The computer system of Embodiment 1 includes a task management node 100 and a plurality of task processing nodes 200. The task management node 100 is coupled to the task processing nodes 200 through a network 300. The network 300 may be a local area network (LAN), a wide area network (WAN) or the like. The connection to the network 300 may be either wired or wireless. The task management node 100 may be directly coupled to the task processing nodes 200.

Each task processing node 200 is a computer configured to construct a distributed database and executes a task using data 221 stored in the distributed database. The distributed database is built on the storage areas provided by the task processing nodes 200.

This embodiment is described based on the assumption that the distributed database is a KVS. The KVS stores key-value pairs as a plurality of pieces of data 221. It should be noted that the application of this invention is not limited to the KVS. The same advantageous effects can be achieved on various types of distributed databases.

The task management node 100 manages assignment of tasks to the task processing nodes 200. More specifically, upon receipt of an execution request of a task from a client terminal, the task management node 100 performs a data inquiry for inquiring about presence of data to be used in the task to each task processing node 200. The task management node 100 also determines the task processing node 200 where to assign the task based on the responses to the data inquiry.

Now, the hardware and software configurations of the task management node 100 and the task processing node 200 are described. First, the configuration of the task management node 100 is described.

The task management node 100 includes a CPU 101, a memory 102, and a network interface 103.

The CPU 101 executes programs stored in the memory 102. The CPU 101 performs processing in accordance with a program to work as a module for implementing a predetermined function. Hereinafter, description having a subject of a module means that the CPU 101 executes the program for implementing the module.

The memory 102 stores programs to be executed by the CPU 101 and information to be used by the programs. The memory 102 includes a work area to be used by the programs on a temporary basis. The programs and information stored in the memory 102 will be described later.

The network interface 103 is an interface for communicating with the other apparatuses through the network 300.

Now, the programs and the information stored in the memory 102 are described. The memory 102 in this embodiment stores a program for implementing a task management module 111. And the memory 102 in this embodiment stores node management information 112, and filtering information 113.

The task management module 111 is configured to receive the execution request of the task, analyze the execution request of the task to identify data to be used by the task, and perform the data inquiry. In this embodiment, the task management module 111 identifies the task processing nodes 200 to be performed the data inquiry before performing the data inquiry, and performs the data inquiry to the identified task processing nodes 200.

The task management module 111 also selects a task processing node 200 where to assign the task based on the results of the data inquiry and assigns the task to the selected task processing node 200.

The task management module 111 includes an index management module 131, a task assignment module 132, and a search inquiry module 133.

The index management module 131 instructs each task processing node 200 to generate or update index information 222. The index management module 131 also generates filtering information 113.

The task assignment module 132 analyzes the execution request of the task, identifies the task processing nodes 200 to be performed the data inquiry based on the analysis result and the filtering information 113, and then invokes the search inquiry module 133. The task assignment module 132 also selects a task processing node 200 where to assign the task based on the responses to the data inquiry and assigns the task to the selected task processing node 200.

The search inquiry module 133 performs the data inquiry to the task processing nodes 200 selected by the task assignment module 132.

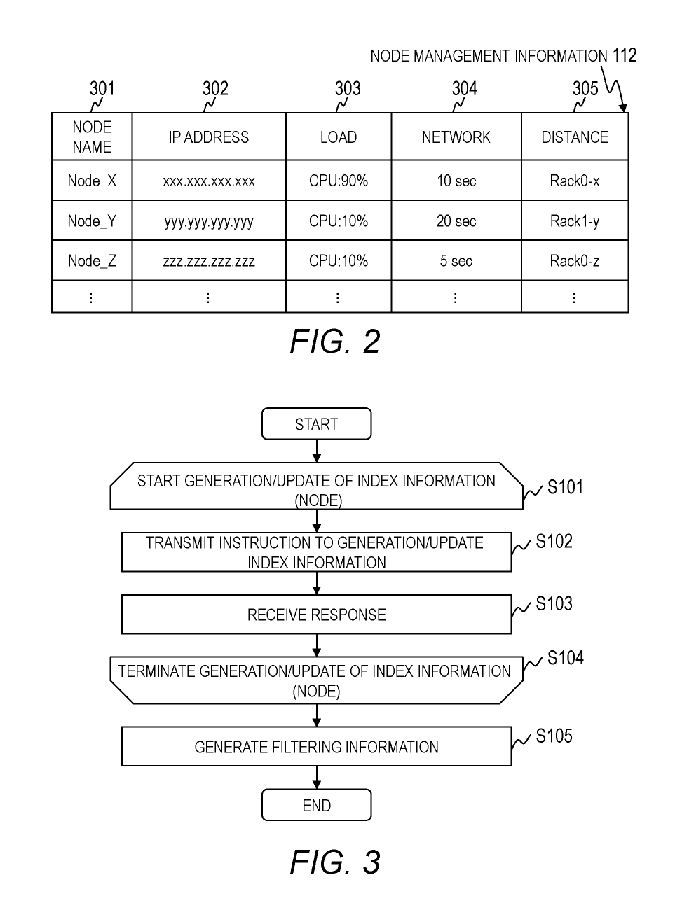

The node management information 112 stores information for managing the configurations and operating conditions of the task processing nodes 200. The details of the node management information 112 will be described with FIG. 2. The node management information can be called computer management information.

The filtering information 113 stores information to be a reference for identifying the task processing nodes 200 to be performed the data inquiry. The filtering information 113 may be bit arrays of Bloom filter, for example. Alternatively, the filtering information 113 may be a list which the identification information of each task processing node 200 is associated with a value of data 221.

It is assumed that the algorithm specifying the method of performing the data inquiry is predetermined. Other than the method using a Bloom filter, a method of sequentially performing inquiry to the task processing nodes 200 one by one or a method of simultaneously performing inquiry to all the task processing nodes 200 can be employed.

Next, the configuration of the task processing node 200 is described.

The task processing node 200 includes a CPU 201, a memory 202, a storage device 203, and a network interface 204. The CPU 201, the memory 202, and the network interface 204 are the same as the CPU 101, the memory 102, and the network interface 103, respectively; accordingly, the description is omitted here.

The storage device 203 stores data on a permanent basis. The storage device 203 may be a hard disk drive (HDD), a solid state drive (SSD) or the like. In this embodiment, the distributed database is built on the storage areas of the storage device 203. The distributed database can be built on the storage areas of the memory 202. Alternatively, the distributed database can be built on the storage areas of the memory 202 and the storage device 203.

The memory 202 stores programs for implementing a search engine 211 and a data management module 212.

The search engine 211 searches data using index information 222. The search engine 211 generates and updates the index information 222. Upon receipt of the data inquiry from the task management node 100, the search engine 211 refers to the plurality of pieces of data 221 to determine whether a designated data exists, and transmits a response including the determination result to the task management node 100. Furthermore, in a case where a task is assigned, the search engine 211 obtains data to be processed using the index information 222 and executes the assigned task using the obtained data.

The function to execute a task does not need to be included in the search engine 211 and can be provided as a task execution module.

The data management module 212 manages the distributed database. More specifically, the data management module 212 controls accesses to the data 221 stored in the distributed database.

The storage device 203 stores the plurality of pieces of data 221 and the index information 222.

Each of the plurality of pieces of data 221 is the data stored in the distributed database. The index information 222 stores information to be used by the search engine 221 to search the data 221 stored in the distributed database 221. In this embodiment, the index information 222 for searching the data 221 managed by the task processing node 200 running the search engine 211, is generated.

The index information 222 is information to allow a Key, a Value, the name of data, the type of data, and/or the range of data to be used as a search key in searching the data 221. For example, the index information 222 can be a list which search keys (index keys) are associated with storage locations of data 221, such as URLs or directory names.

FIG. 2 is a diagram for illustrating an example of the node management information 112 held by the task management node 100 in Embodiment 1.

The node management information 112 includes entries consisting of a node name 301, an IP address 302, a load 303, a network 304, and a distance 305. One entry corresponds to a task processing node 200. The entries can include fields other than the foregoing fields. For example, each entry can include fields for storing values representing the capability of the CPU 201 and the memory 202 of the task processing node 200.

The node name 301 is a field for storing identification information of the task processing node 200. The IP address 302 is a field for storing IP address assigned to the task processing node 200.

The load 303 is a field for storing information indicating the processing load to the task processing node 200. In this embodiment, the load 303 stores the usage of the CPU 201. The load 303 may store the value of the memory usage, the number of tasks being executed by the task processing node 200, or the like.

The network 304 is a field for storing information indicating the communication load to the task processing node 200. In this embodiment, the network 304 stores the communication latency. The network 304 may store the value of jitter, packet discard rate, or the like.

The distance 305 is a field for storing information indicating the physical distance between the task management node 100 and the task processing node 200. In this embodiment, the distance 305 stores information indicating the location where the task processing node 200 is installed.

FIG. 3 is a flowchart of an example of processing to be performed by the index management module 131 in Embodiment 1.

In a case of receiving a request to generate or update index information 222, the index management module 131 starts the index information generating or update processing described hereinbelow (Step S101). At this step, the index management module 131 selects a target task processing node 200 from the plurality of task processing nodes 200.

The request to generate or update index information 222 is issued by the task management module 111 when a task processing node 200 is added, when data 221 is added to the distributed database, or periodically.

The index management module 131 transmits an instruction to generate or update index information 222 to the target task processing node 200 (Step S102). The index management module 131 stands by until receipt of a response from the target task processing node 200.

In a case of receiving the instruction, the search engine 211 of the target task processing node 200 generates or updates index information 222 with reference to the data 221. After generating or updating the index information 222, the search engine 211 transmits a response for notifying a completion of the processing to the task management node 100.

In this embodiment, the target task processing node 200 transmits information on each of the plurality of pieces of data 221 held by the target task processing node 200 together as information for the response. For example, in the case of employing Bloom filter, the target task processing node 200 transmits the values of hash functions obtained from each of the plurality of pieces of data 221 used as an input. Alternatively, the target task processing node 200 may transmit the metadata of each of the plurality of pieces of data 221.

In a case of receiving the response from the target task processing node 200 (Step S103), the index management module 131 determines whether the processing has been completed on all the task processing nodes 200 (Step S104).

In a case where it is not determined that the processing has been completed on all the task processing nodes 200, the index management module 131 returns to Step S101 and selects a new target task processing node 200.

In a case where it is determined that the processing has been completed on all the task processing nodes 200, the index management module 131 generates the filtering information 113 (Step S105). Thereafter, the index management module 131 terminates the processing.

In the case of employing Bloom filter, the index management module 131 generates bit arrays as filtering information 113, based on the values of the hash functions received from the task processing nodes 200.

As mentioned in the description of FIG. 1, each task processing node 200 in this embodiment generates index information 222 for searching the data 221 stored in its own storage areas in view of the locality. This configuration enables task assignment in view of the locality. Furthermore, the size of the index information 222 is small enough to search the data speedily and utilize the storage areas efficiently.

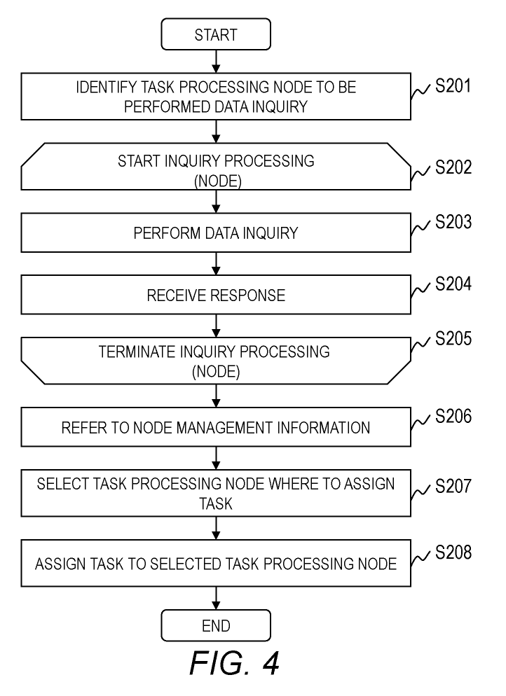

FIG. 4 is a flowchart of an example of processing to be performed by the task assignment module 132 in Embodiment 1.

The task assignment module 132 starts the processing described hereinafter in a case of receiving the execution request of the task from the client terminal. The execution request of the task includes information for identifying the data 221 to be used by the task, such as the name of the data, the type of the data, the value range, or the like. In the following description, the data 221 to be used by the task can be referred to as target data 221.

The task assignment module 132 identifies the task processing nodes 200 to be performed the data inquiry (Step S201).

Specifically, the task assignment module 132 analyzes the execution request of the task to obtain the information for identifying the target data 221. Using this information and the filtering information 113, the task assignment module 132 identifies the task processing nodes 200 expected to hold the target data 221 to be the task processing nodes 200 to be performed the data inquiry. For example, in the case where the filtering information 113 is a list in which the identification information of the task processing nodes 200 is associated with the Value of the data 221, the task assignment module 132 obtains identification information of the task processing nodes 200 associated with a Value of data 221 with reference to the filtering information 113. Through this operation, the task assignment module 132 can identify the task processing nodes 200.

By using the filtering information 113, the number of task processing nodes 200 to be performed the data inquiry can be reduced. Therefore, it can be reduced the system load due to performing the inquiry and it is possible to realize high-speed processing.

In addition to the information for identifying the target data 221 and the filtering information 113, the task assignment module 132 may further refer the node management information 112 to identify the task processing nodes 200 to be performed the data inquiry.

The task assignment module 132 starts inquiry processing (Step S202). At this step, the task assignment module 132 selects one target task processing node 200 from the identified task processing nodes 200.

The task assignment module 132 performs the data inquiry to the target task processing node 200 (Step S203). In the data inquiry, information for identifying the target data 221 is transmitted.

In a case of receiving the data inquiry, the search engine 211 of the task processing node 200 refers to the index information 222 to search the target data 221 based on the information for identifying the target data 221. For example, the search engine 211 refers to the index information 222 to search records matching the Value, the name of data, the type of data, or the range of data. The search engine 211 transmits a response including the search result to the task management node 100. The search result includes at least information indicating whether the target data exists. The search result can further include information on the retrieved target data. For example, the search result may include information indicating the number of a plurality of pieces of retrieved target data 221 and the type of the retrieved target data 221.

In a case of receiving the response from the target task processing node 200 (Step S204), the task assignment module 132 determines whether the inquiry processing has been completed on all the identified task processing nodes 200 (Step S205).

In a case where it is not determined that the inquiry processing has been completed on all the determined task processing nodes 200, the task assignment module 132 returns to Step 5202 and selects a new target task processing node 200.

In a case where it is determined that the inquiry processing has been completed on all the determined task processing nodes 200, the task assignment module 132 refers to the node management information 112 (Step S206) and selects at least one of the task processing nodes 200 where to assign the task (Step S207). For example, the processing described hereinbelow can be performed.

In a case where there are a plurality of task processing nodes 200 holding the target data 221, the task assignment module 132 selects a predetermined number of task processing nodes 200 in ascending order of the CPU usage. Alternatively, the task assignment module 132 may select task processing nodes 200 having network latency shorter than a predetermined threshold. In other words, task processing nodes 200 whose processing load is low or whose processing time is short are selected.

In a case where the task processing nodes 200 holding target data 221 have high load, the task assignment module 132 selects different task processing nodes 200 having a low CPU usage, a task processing node 200 physically locating at a short distance, or a task processing node 200 having a short network latency. In other words, task processing nodes 200 whose processing load is low or whose processing time is short are selected among the task processing nodes 200 not holding target data 221.

In this case, the task assignment module 132 transmits information including the identification information on the task processing nodes 200 holding the target data 221 to the at least one selected task processing node 200. This configuration enables the at least one selected task processing node 200 to obtain the target data 221 without performing the data inquiry.

In this embodiment, the task assignment module 132 assigns tasks to the at least one of the task processing nodes 200 so that the tasks to be executed are balanced among the task processing nodes 200, based on the node management information 112. This configuration can prevent a bottleneck caused by concentration of tasks onto one task processing node 200.

It is assumed that a selection rule and a selection number are predetermined. However, the selection rule and the selection number can be updated as necessary. The foregoing is an example of the processing of Step S207.

The task assignment module 132 assigns the task to the at least one selected task processing node 200 (Step S208) and terminates the processing.

As an option, the task assignment module 132 may terminate the loop processing in a case of receiving a response indicating possession of target data 221. In this case, the task assignment module 132 treats the task processing nodes 200 not to be performed the data inquiry as task processing nodes 200 not holding target data 221. The task assignment module 132 omits the processing of Steps S206 and S207, and assigns the task to the task processing node 200 that has transmitted the aforementioned response at Step S208.

In the case of assigning the task to a plurality of task processing nodes 200, the task assignment module 132 may assign a task for performing the same processing to each of the plurality of task processing nodes 200 or a task for performing different processing to the each of the plurality of task processing nodes 200.

It is also conceivable that the at least one selected task processing node 200 may not be able to execute the task. To address the issue, the task assignment module 132 may transmit task transfer information including identification information of the task processing nodes 200 that are not selected at Step S207. If the at least one selected task processing node 200 assigned a task cannot execute the task, the at least one selected task processing node 200 assigns the task to another task processing node 200 based on the task transfer information. This configuration eliminates the task assignment module 132 from executing the inquiry processing again.

According Embodiment 1, it can perform the data inquiry to the each task processing node 200 because each task processing node 200 holds the index information 222. For this reason, accesses to the index information 222 in assigning a task can be distributed. Furthermore, the load of processing the data inquiry can be reduced by scaling out the task processing node 200.

In a case where a new task processing node 200 is added, the index information 222 needs to be generated only in the added task processing node 200. Since the index information 222 held by each of the task processing nodes 200 does not depend on the index information 222 held by the other task processing nodes 200, the task processing nodes 200 do not have to transmit the index information 222 to one another. Accordingly, increase in communication caused by addition of a task processing node 200 and scale out can be easily done. In similar, when new data is added, increase in communication among task processing nodes 200 can be kept low.

Furthermore, since the node for managing data 221 is the same as the node for managing index information 222, the management can also be facilitated.

Still further, since the task is assigned to the task processing node 200 holding data, the communication among the task processing nodes 200 can be reduce. Accordingly, communication among the task processing nodes 200 caused by execution of the task can be kept low.

### Embodiment 2

In Embodiment 2, the functions of the task management node 100 are included in each task processing node 200. In the following, Embodiment 2 is described mainly in differences from Embodiment 1. Description of the configuration, information, and processing in common with those in Embodiment 1 is omitted.

The computer system in Embodiment 2 does not include the task management node 100. The each task processing node 200 has the task management module 111, the node management information 112, and the filtering information 113. The other configuration of the task processing node 200 is the same as that of the task processing node 200 in Embodiment 1.

In Embodiment 2, the each task processing node 200 has the functions of the task management node 100. Accordingly, the each task processing node 200 can receive the execution request of the task from the client terminal.

The processing performed by the index management module 131 in Embodiment 2 is the same as the processing described in Embodiment 1. The search engine 211 does not have to generate or update index information 222 until elapse of a predetermined time after receipt of the latest instruction to generate or update index information 222 because the index management module 131 in each task processing node 200 can perform the processing.

The processing performed by the task assignment module 132 in Embodiment 2 is the same as the processing described in Embodiment 1.

The computer system in Embodiment 2 can have the same advantageous effects as the computer system in Embodiment 1.

Representative aspects of the invention other than the aspects recited in the claims are recited as follows:

(1) A non-transitory computer readable medium stores program to be executed by a management computer managing a plurality of computers providing a database,

the management computer including a processor, a storage device coupled to the processor, and a network interface coupled to the processor,

the computer program being configured to make the management computer perform:

a first step of identifying data to be used in first processing in a case of receiving a request to execute the first processing;

a second step of performing data inquiry for inquiring about presence of the data to be used in the first processing to the plurality of computers providing the database;

a third step of identifying at least one computer holding the data to be used in the first processing, based on first responses to the data inquiry; and

a fourth step of assigning the first processing to the at least one identified computer.

(2) The non-transitory computer readable medium stores the program according to the foregoing (1),

wherein the management computer holds filtering information for identifying computers to be performed the data inquiry, and

wherein the first step includes a step of identifying a plurality of computers to be performed the data inquiry based on the filtering information.

(3) The non-transitory computer readable medium stores the program according to the foregoing (2),

wherein the program is configured to make the management computer further perform:

a step of instructing each of the plurality of computers providing the database to generate index information for searching data stored in storage areas allocated to the database;

a step of receiving a second response including information on the data stored in the storage areas allocated to the database from the each of the plurality of computers providing the database; and

a step of generating the filtering information based on the second responses received from the plurality of computers providing the database.

(4) The non-transitory computer readable medium stores the program according to the foregoing (3),

wherein the management computer holds condition management information for managing conditions of the plurality of computers providing the database, and

wherein the fourth step includes:

a step of referring to the condition management information in a case where there are a plurality of computers holding the data to be used in the first processing;

a step of selecting either a computer whose load of the first processing is small or a computer that completes the first processing in a short time out among the plurality of computers holding the data to be used in the first processing; and

a step of assigning the first processing to the selected computer.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, and Java (registered trademark).

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A computer system comprising a plurality of computers,
each of the plurality of computers including a processor, a storage device coupled to the processor, and a network interface coupled to the processor,
the computer system having a database built on a plurality of storage areas included in at least one of the plurality of computers,
the processor of at least one computer being configured to:
identify data to be used in first processing in a case of receiving a request to execute the first processing;
perform data inquiry for inquiring about presence of the data to be used in the first processing to at least one of the plurality of computers providing the database;
identify at least one of the plurality of computers holding the data to be used in the first processing, based on at least one of a plurality of first responses to the data inquiry; and
assign the first processing to the at least one of the plurality of identified computers holding the data to be used in first processing.

2. The computer system according to claim 1,
wherein the at least one computer holds filtering information for selecting at least one computer to be performed the data inquiry, and
wherein the processor of the at least one computer is configured to identify the at least one computer to be performed the data inquiry based on the filtering information.

3. The computer system according to claim 2,
wherein the processor of the at least one computer is configured to:
instruct the at least one of the plurality of computers providing the database to generate index information for searching data stored in the plurality of storage areas allocated to the database;
receive at least one of a plurality of second responses including information on the data stored in the plurality of storage areas allocated to the database from the at least one of the plurality of computers providing the database; and
generate the filtering information based on the at least one of the plurality of second responses received from the at least one of the plurality of computers providing the database, and
wherein the processor of the at least one of the plurality of computers providing the database is configured to:
generate the index information in a case of receiving the instruction to generate the index information;
transmit a second response;
retrieve the data to be used in the first processing from the plurality of storage areas allocated to the database based on the index information in a case where the first processing is assigned; and
execute the first processing using the retrieved data to be used in the first processing.

4. The computer system according to claim 3,
wherein the at least one computer holds computer management information for managing configurations and operating conditions of the at least one of the plurality of computers providing the database, and
wherein the processor of the at least one computer is configured to:
refer to the computer management information in a case where there are a plurality of computers holding the data to be used in the first processing;
select, among the plurality of computers holding the data to be used in the first processing, a computer whose load of the first processing is small or a computer that completes the first processing in a short time out; and
assign the first processing to the selected computer.

5. A method of assigning processing in a computer system,
the computer system including:
a plurality of computers, and
a database built on a plurality of storage areas included in at least one of the plurality of computers,
each of the plurality of computers including a processor, a storage device coupled to the processor, and a network interface coupled to the processor,
the method comprising:
a first step of identifying, by the processor of at least one computer, data to be used in first processing in a case of receiving a request to execute the first processing;
a second step of performing, by the processor of the at least one computer, data inquiry for inquiring about presence of the data to be used in the first processing to at least one of the plurality of computers providing the database;
a third step of identifying, by the processor of the at least one computer, at least one of the plurality of computers holding the data to be used in the first processing, based on at least one of a plurality of first responses to the data inquiry; and
a fourth step of assigning, by the processor of the at least one computer, the first processing to the at least one of the plurality of identified computers holding the data to be used in the first processing.

6. The method of assigning processing according to claim 5,
wherein the at least one computer holds filtering information for selecting at least one computer to be performed the data inquiry, and
wherein the first step includes a step of identifying, by the processor of the at least one computer, the at least one computer to be performed the data inquiry based on the filtering information.

7. The method of assigning processing according to claim 6, further comprising:
a step of instructing, by the processor of the at least one computer, the at least one of the plurality of computers providing the database to generate index information for searching data stored in the plurality of storage areas allocated to the database;
a step of generating, by the processor of the at least one of the plurality of computers providing the database, the index information in a case of receiving the instruction to generate the index information;
a step of transmitting, by the processor of the at least one of the plurality of computers providing the database, a second response including information on the data stored in the plurality of storage areas allocated to the database;
a step of receiving, by the processor of the at least one computer, at least one of a plurality of second responses from the at least one of the plurality of computers providing the database; and
a step of generating, by the processor of the at least one computer, the filtering information based on the at least one of the plurality of second responses received from the at least one of the plurality of computers providing the databases,
wherein the fourth step includes:
a step of retrieving, by the processor of the at least one of the plurality of computers providing the database, the data to be used in the first processing from the plurality of storage areas allocated to the database based on the index information in a case where the first processing is assigned; and
a step of executing, by the processor of the at least one of the plurality of computers providing the database, the first processing using the retrieved data to be used in the first processing.

8. The method of assigning processing according to claim 7,
wherein the at least one computer holds computer management information for managing configurations and operating conditions of the at least one of the plurality of computers providing the database, and
wherein the fourth step includes:
a step of referring, by the processor of the at least one computer, to the computer management information in a case where there are a plurality of computer holding the data to be used in the first processing;
a step of selecting, by the processor of the at least one computer, among the plurality of computers holding the data to be used in the first processing, a computer whose load of the first processing is small or a computer that completes the first processing in a short time out; and
a step of assigning, by the processor of the at least one computer, the first processing to the selected computer.

9. A computer system comprising:
a plurality of task processing nodes configured to provide a database; and
a task management node configured to assign a task to a task processing node,
wherein each of the plurality of task processing nodes includes a first processor, a first memory coupled to the first processor, a storage device coupled to the first processor, and a first network interface coupled to the first processor,
wherein the task management node includes a second processor, a second memory coupled to the second processor, and a second network interface coupled to the second processor,
wherein the each of the plurality of task processing nodes includes:
a data management module configured to control input and output of data to the database; and
a search engine configured to retrieve data from the database,
wherein the task management node includes:
a task management module configured to control assignment of tasks to the plurality of task processing nodes;
node management information for managing conditions of the plurality of task processing nodes; and
filtering information for selecting at least one of task processing node to be performed data inquiry for inquiring about presence of data to be used in a task,
wherein the task management module is configured to:
identify data to be used in a first task by analyzing a request to execute the first task in a case of receiving the request;
identify at least one task processing node to be performed the data inquiry for inquiring about presence of the data to be used in the first task based on the filtering information;
perform the data inquiry to the at least one identified task processing nodes;
receive at least one of a plurality of responses to the data inquiry;
select a task processing node where to assign the first task based on the at least one of the plurality of responses and the node management information; and
assign the first task to the selected task processing node, and
wherein the search engine is configured to:
generate index information for searching data stored in storage areas provided by each of the plurality of task processing nodes running the search engine and allocated to the database;
retrieve the data to be used in the first task among a plurality of pieces of data stored in the plurality of storage areas allocated to the database based on the index information in a case where the first task is assigned; and
execute the first task using the retrieved data to be used in the first task.
